(19) United States
(12) Patent Application Publication
(10) Pub. No.: US 2009/0266390 A1
(43) Pub. Date: Oct. 29, 2009

(54) Mobile automated-hand car wash

(76) Inventor: Brad Pollack, E. Brunswick, NJ (US)

Correspondence Address: Brad Pollack, 37 Appleby Ln., E. Brunswick, NJ, 08816, US

(21) Appl. No.: 12/150,339

(22) Filed: Apr. 28, 2008

(51) Int. Cl. B08B 3/04

(52) U.S. Cl. 134/57 R; 134/56 R

(57) ABSTRACT

Modular structures, machinery and modes of connectivity that are currently available have never been assembled to create a mobile automated-hand car wash or any other structure will similar design or purpose. I propose a design and method for constructing a mobile and automated-hand car wash utilizing automated water and soap applicators, electric powered commercial dryers and professional car washers to clean the vehicle by hand mid-process. The assembled facility enables operation with the speed of an automated car wash and the quality of a hand wash. The completed structure includes 4 individual modular buildings, and 1 platform that are delivered to the site via flatbed, secured, assembled and connected to utilities. The modular structures allow the entire facility to be moved by disconnecting the public utilities, water pipes and power lines running from building to building, and using a flat bed truck to transport the individual structures to a new location. The mobility of the facility enables the land owner to avoid altering or making major improvements to the land site in order to operate an automated car wash; nor will the landowner need to be locked into a long term contract that would be normal under the circumstances of a land lease, or developing a pad site. The green design which includes water filtering and recycling equipment, solar panels on the rooftop, and environmentally friendly chemicals and cleaning products further promotes the use of this facility by having no adverse effects on the land or public sewage. In fact the green design saves significantly on the amount of public water and electric power used to operate the mobile automated-hand car wash.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The building of automated car washes normally requires the construction of a permanent structure. As a permanent structure, a tunnel car wash would require a sizeable investment to construct the building and have a difficult time gaining approval from a land owner (in the circumstance where the car wash operator does not own the land) to place the car wash on an unused portion of the land, similar to a parking lot of a retail center. By creating a mobile automated car wash the land owner will not have to alter or make major improvements to the land site in order to allow an automated car wash; nor will the landowner need to be locked into a long term contract that would be normal under the circumstances of a land lease, or developing a pad site.

The automated car wash provides the speed needed to handle a significant volume of vehicles each day. The problem is that the quality of an automated car wash is never as good as a hand wash. Using automated mitters and washers have left scratches and swirl marks on the exterior of vehicles. Therefore we have designed a structure and process that will utilize components of both a traditional automated wash and hand wash service. By doing so we are able to offer the speed of an automated wash with the quality of a hand wash.

By constructing the entire structure in an environmentally friendly design, we will be able to drastically reduce the water and power used from the public utilities by using a water filtering and recycling system, along with solar panels on the rooftop. All cleaning products used on the vehicles are VOC compliant and in no way harmful to the vehicle or the environment.

### BRIEF SUMMARY OF THE INVENTION

The mobile automated-hand car wash represents the first automated car wash that can be transported and easily assembled/disassembled. The mobile design enables the car wash operator to place the facility on a property without the landowner being locked into a long term land lease contract, and avoid the landowner from building a permanent car wash structure which requires a substantial up front investment. The mobile automated-hand wash facility uses four modular buildings able to be delivered to the site and assembled/disassembled as required. The four modular buildings serve a specific purpose in the car wash process:
1. 10′W*25′L*8′6″H structure to pre-rinse the vehicle and apply soap.
2. 10′W*25′L*8′6″H structure to rinse the vehicle and dry the vehicle.
3. 8′W*20′L*8′6″H structure to serve as an office and waiting area.
4. 8′W*40′L*8′6″H structure to serve as a machine room and supply storage.

The mobile automated-hand car wash requires an open air platform 10′W*20′L to be placed between the two 10′W structures (designates above in line 1 and 2), to allow cleaning professional the ability to wash the vehicle with hand mitts using the soap which was previously applied. The entire tunnel wash system must be constructed above a drainage ditch in order to capture the water and soap run off.

The mobile automated-hand car wash could vary in design and become a mobile automated car wash by using one 40′ long tunnel building for the car wash processes. Instead of using car wash professionals, the tunnel wash may utilize automated mitters and washers to clean the vehicle. Though this option would not provide the quality of the automated-hand wash system, the system will still be mobile and therefore provide the benefits previously described.

In order for the mobile automated-hand car wash to operate a machine room is required. This room will be 8′W*40′L*8′6″H and will be insulated, ventilated, and climate controlled. The size of this room can vary based on the capacity capabilities, but the components of the room will be standard to operate a tunnel car wash system with or without a conveyor or automated washing machines. The pipes from the drainage system will run into the machine room where it will be pumped into the holding tank. The holding tank is filtered and recycled into the clean water holding tanks. The public utilities will be connected to the machine room and redirected using power lines and water pipes to the machine room components, tunnel wash and office structures.

It is recommended but not a requirement that a mobile automated-hand car wash have an office and waiting room. The structure will be 8′W*20′ L*8′6″H and will be insulated, ventilated, and climate controlled. This room will have phone and cable access, and powered through the machine room.

The mobile automated-hand car wash has a green effect that promotes the use of this design. All mobile automated-hand car washes do not have to have a green design, but it is recommended. In order to create an environmentally friendly facility, this structure will utilize water filtering and recycling equipment located in the machine room in order to reuse the fresh water and save thousands of gallons of water each year depending on usage. This system will also capture all chemicals and residue during the car wash processes in order to avoid those chemicals and residues from entering the public sewage system. Another environmentally friendly aspect to the mobile automated-hand car wash is the use of solar panels placed on the rooftop of the facility to supplement power usage from public utilities.

### BRIEF DESCRIPTION OF THE SEVERAL VIEWS OF THE DRAWING

FIG. 1: Site Plan (Illustrates the required building area within a parking lot)

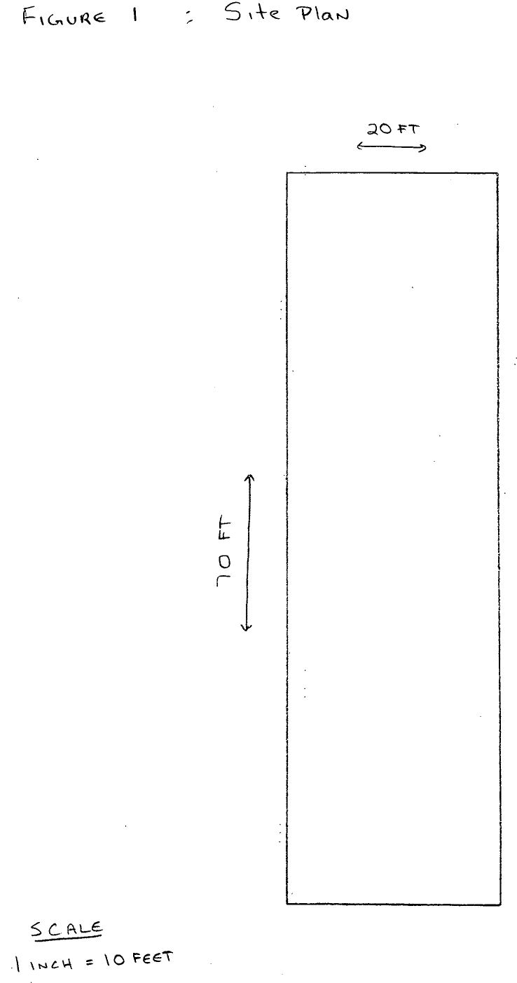

FIG. 2: Site Preparation (Illustrates the size and location for the drainage ditch/pipe)

FIG. 3: Assembled Structure (Illustrates size, location and connectivity of structures)

FIG. 4: Car Lanes (Illustrates the required lane designation for entering and exiting)

FIG. 5.1: Tunnel Wash Modular Structure (Illustrates Side Angled View)

FIG. 5.2: Tunnel Wash Modular Structure (Illustrates Front View)

FIG. 6: Machine Room Modular Structure (Illustrates Side View)

FIG. 7: Office Room Modular Structure (Illustrates Side View)

FIG. 8.1: Assembled Structure (Illustrates Front Entrance View)

FIG. 8.2: Assembled Structure (Illustrates Overhead Angled View)

FIG. 8.3: Assembled Structure (Illustrates Overhead Angled View)

FIG. 8.4: Assembled Structure (Illustrates Office and Machine Room Side View)

FIG. 8.5: Assembled Structure (Illustrates Tunnel Wash Side View)

FIG. 8.6: Assembled Structure (Illustrate Rear Exit View)

FIG. 8.7: Assembled Structure (Illustrates Overhead Birdseye View)

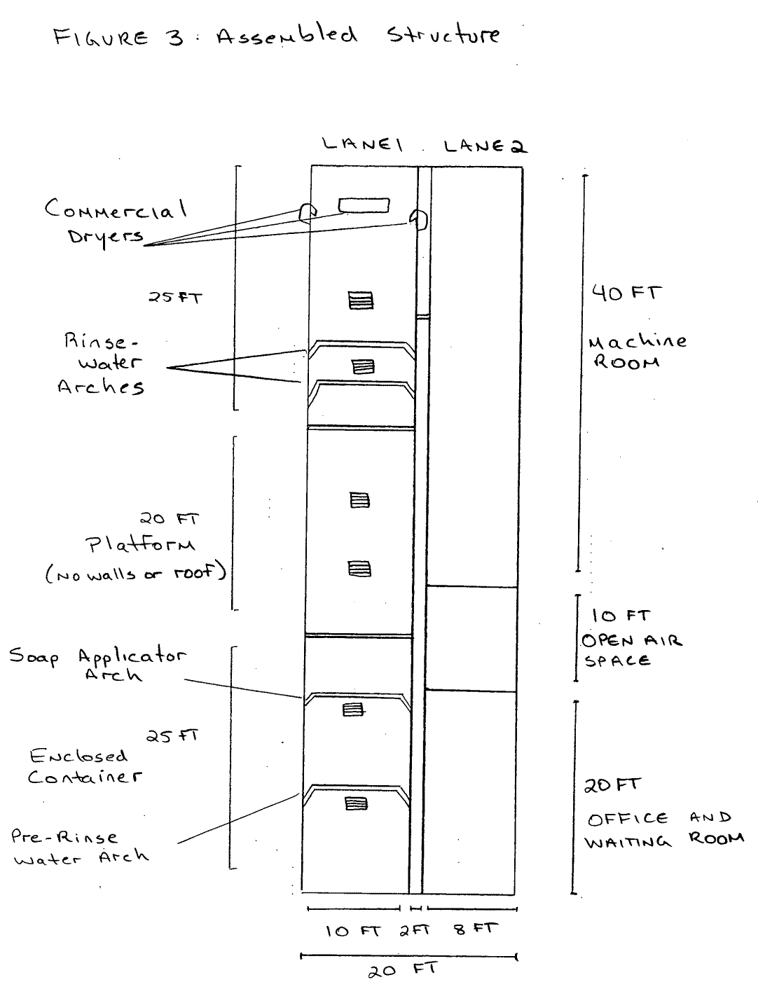

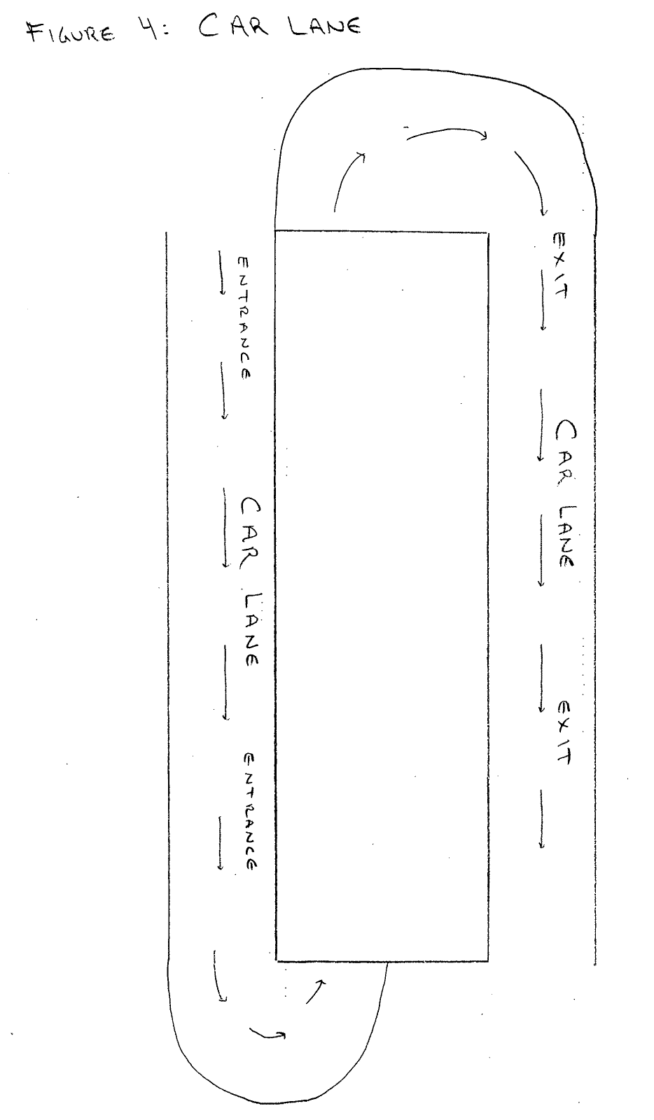

All vehicles will be directed through the Car Entrance Lane as illustrated in FIG. 4, until arriving at the entrance of the tunnel wash, at which time the customer will exit the vehicle and walk a short distance to the waiting and processing room as illustrated in FIG. 3; Lane 2. Instead of using a conveyor system drivers will take the vehicle through each stage of the wash. The vehicles will enter the enclosed 10′W*25′L structure and initially presoaked with recycled water using a high pressure arch system as illustrated in FIG. 3; Lane 1. This arch will soak the vehicle in it's entirety before applying the soap. The next arch will evenly apply the environmentally safe soap to the entire vehicle before moving on to the hand wash section. After the vehicle is presoaked and the soap is applied, the vehicle will move forward to the open air hand wash section. The vehicle will remain on a platform to allow water and soap run off into the drainage system as illustrated in FIG. 3: Lane 1. There will be 4 to 6 hand wash professionals washing the car on the platform using a detail mitt to wash the vehicle with the soap applied by the arch. The car will then enter the next 10′W*25′L structure that will use two high pressure fresh water arches to rinse off the soap before the commercial blowers dry the car as illustrated in FIG. 3; Lane 1. The car will exit the tunnel wash and drive around the structure to the delivery lane in front of the office as illustrated in FIG. 4 as the Car Exit Lane. Auto care professionals will dry off the car by blowing the lines of any additional water, clean the windows and vacuum the interior of the vehicle. The equipment and supplies for finishing the vehicles will be accessed in the 8′W*10′L open space (located in between the office and machine room) as illustrated in FIG. 3; Lane 2.

### DETAILED DESCRIPTION OF THE INVENTION

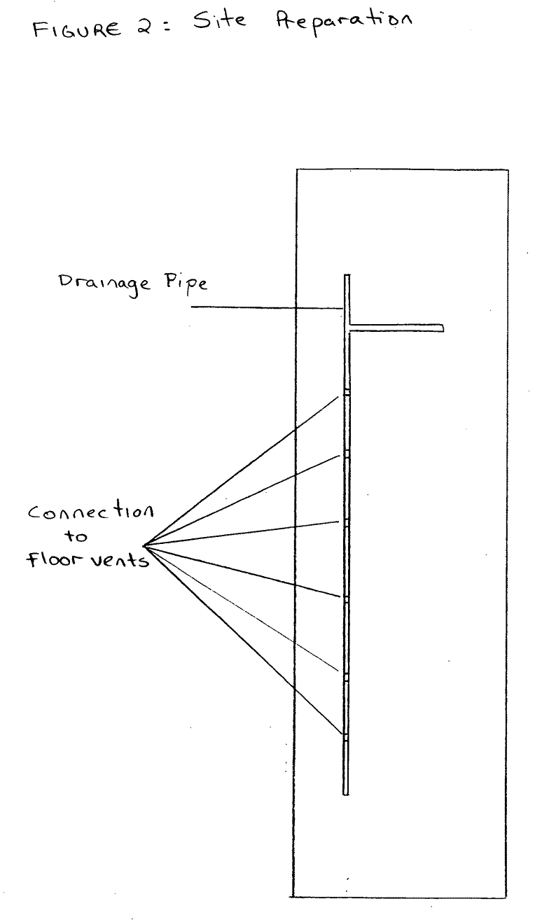

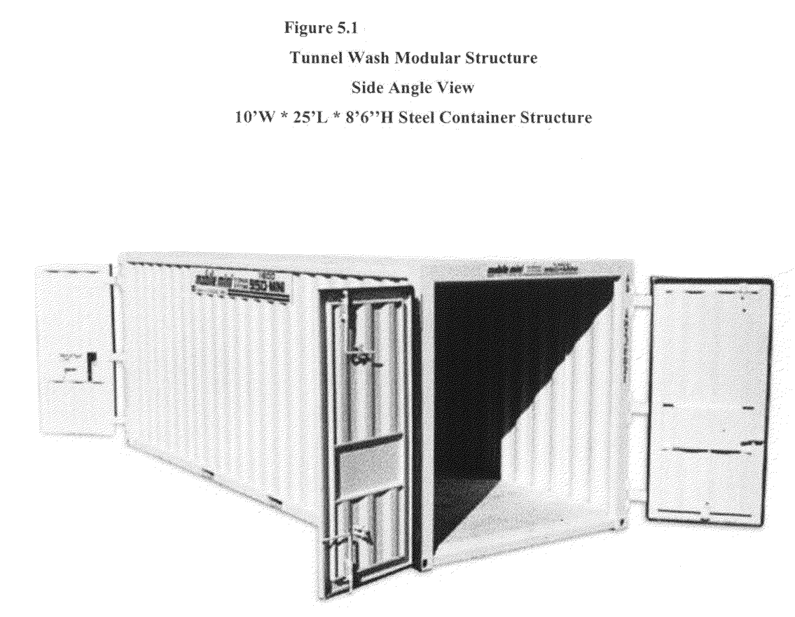

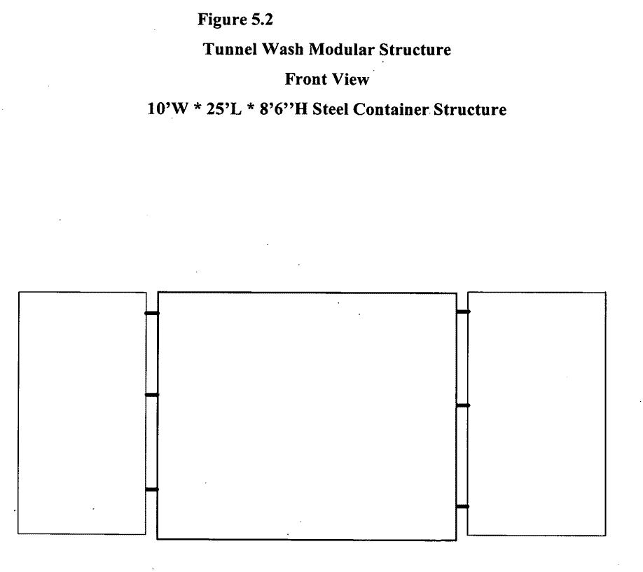

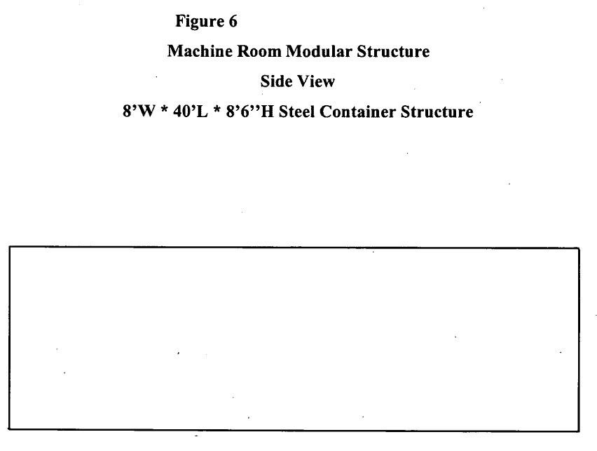

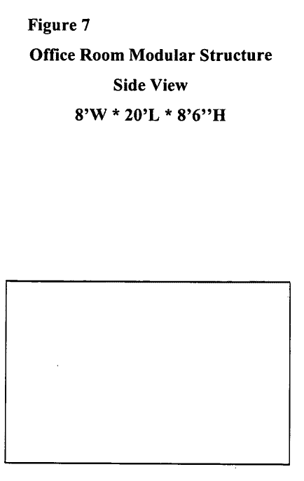

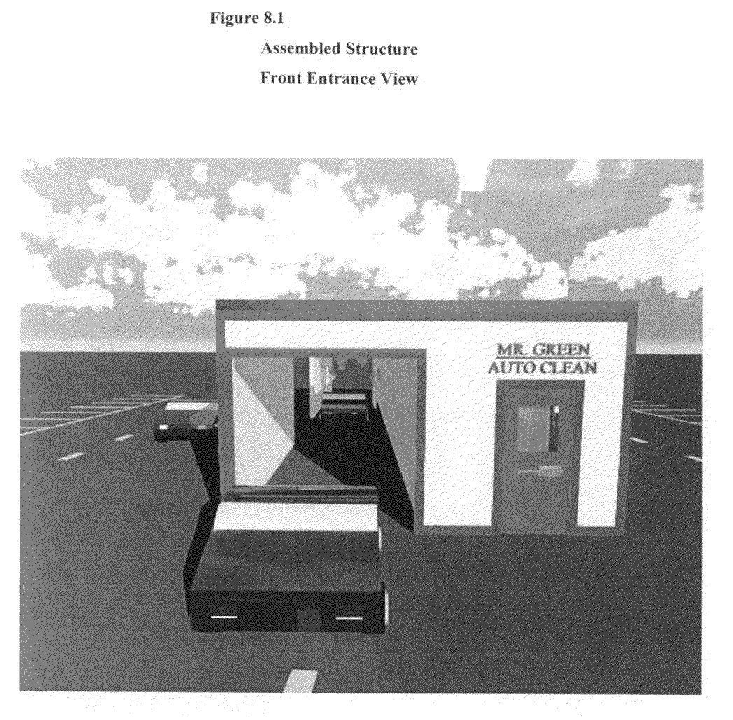

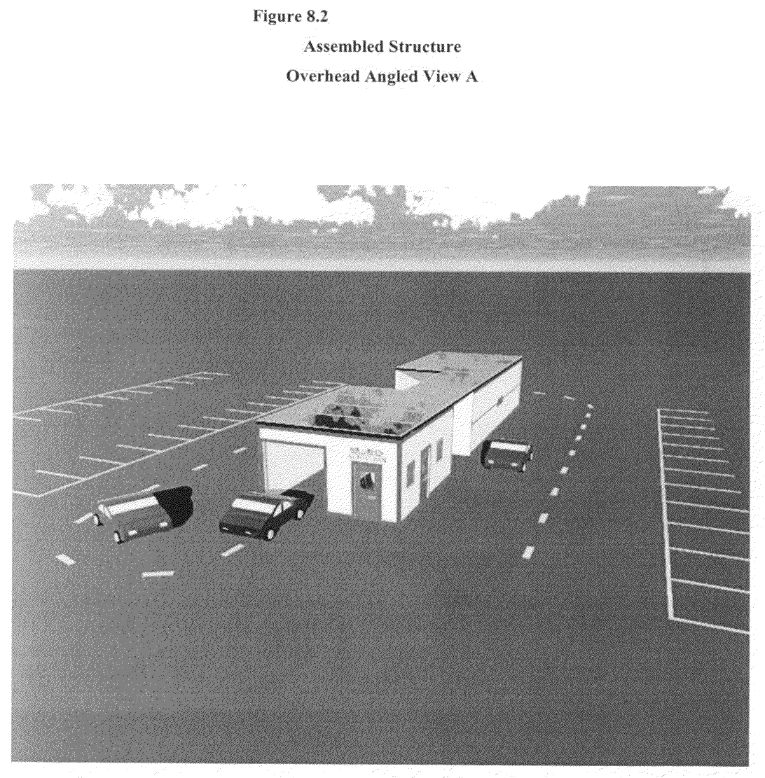

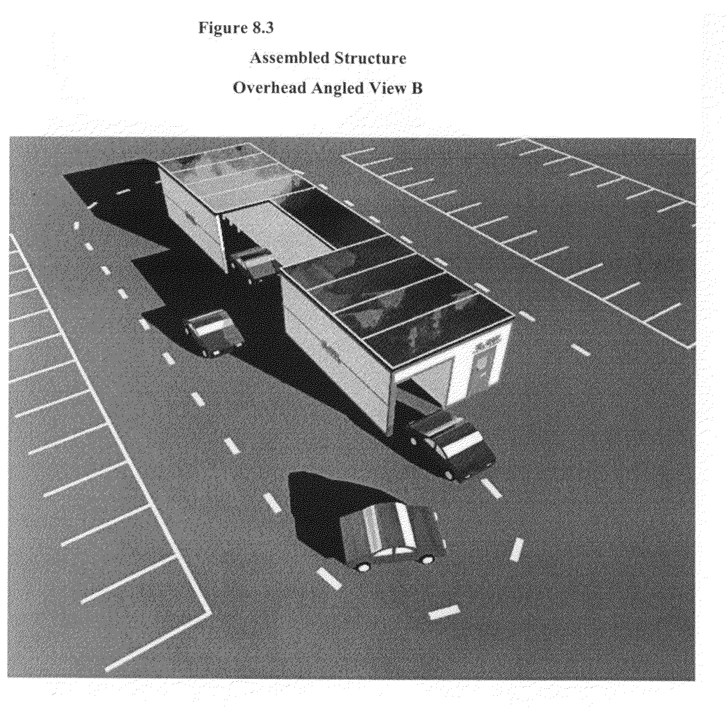

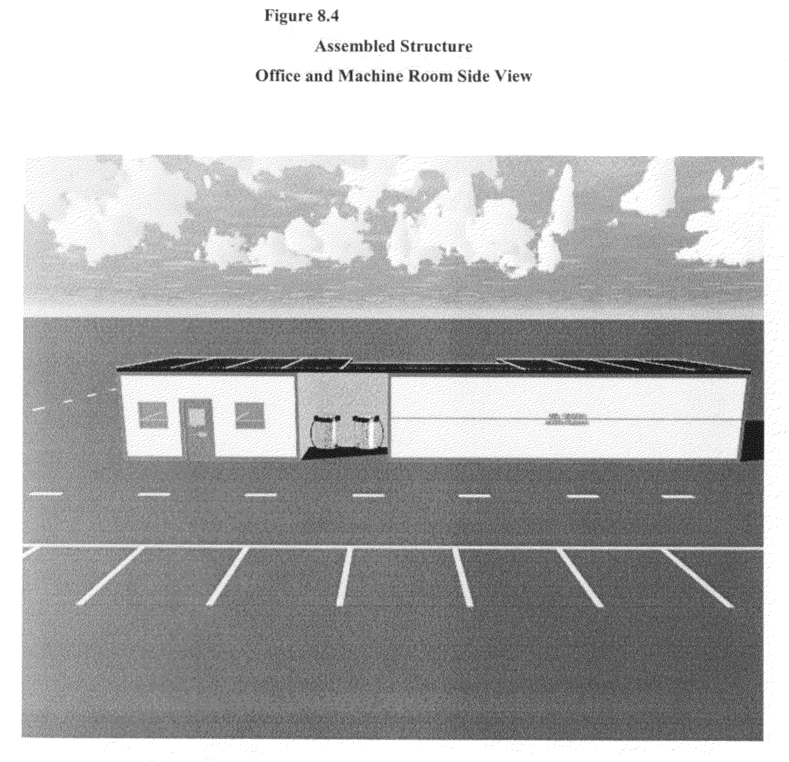

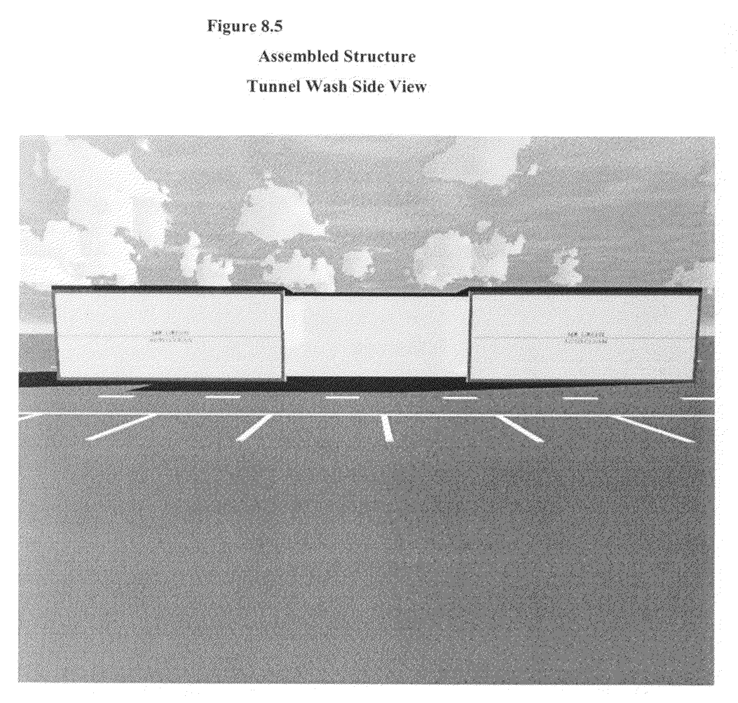

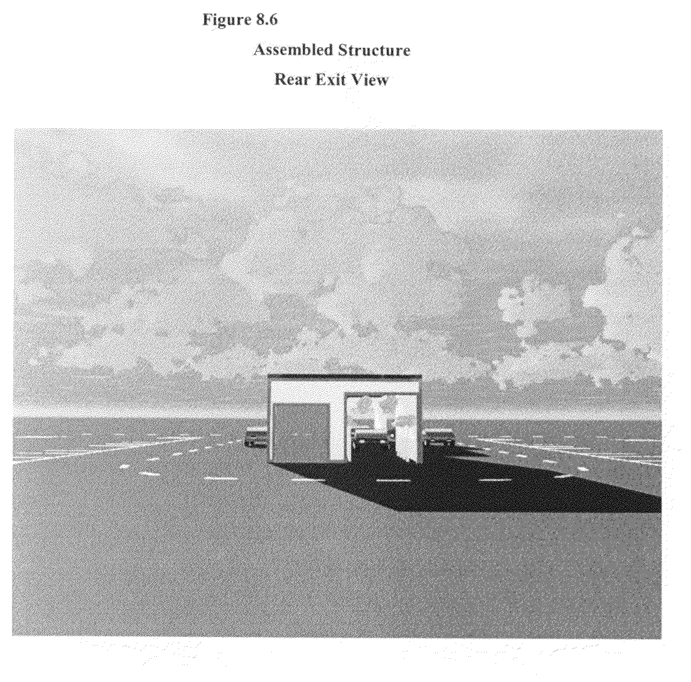

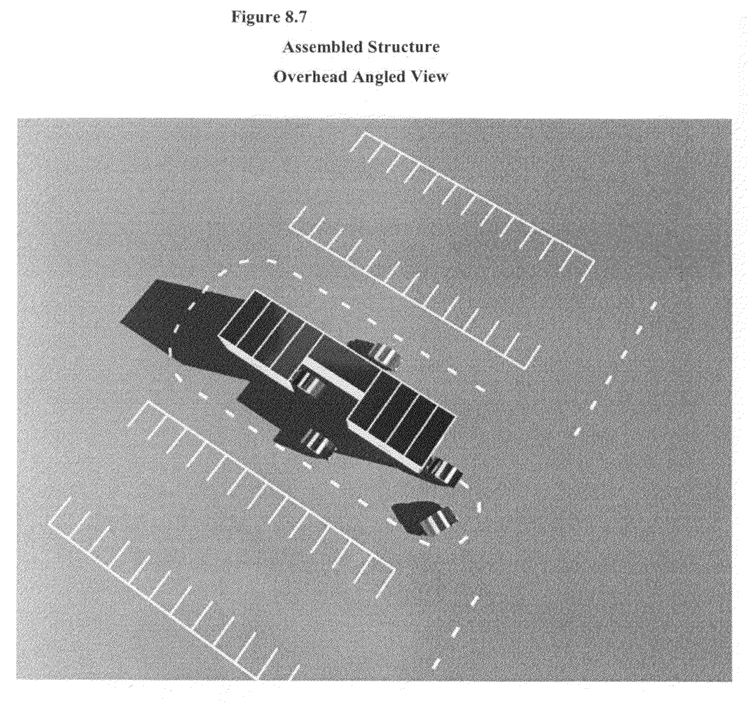

The modular structures, machinery and modes of connectivity are in existence, but the combination of these modular structures, machinery and connectivity have never been combined to create a mobile automated-hand car wash, or any other structure with similar purpose.
1. In order for the facility to operate specific Site Preparation is required.
   a. A drainage system will be created that will require a 1′ wide and 2′ deep L shaped trench to be dug that runs 60′ in length below structures identified in section 2, paragraph a, b and c, and then a 90 degree angle connector to another drainage trench at the end of the drainage pipe located under the structure in section 2 paragraph c that runs 8′ in length leading into the machine room, in order to place a drainage pipe that will capture the water and soap run off from the three structures illustrate in section 1, paragraph a, b and c. The trench will have a pipe that connects to the individual vents for each structure described in section 2, paragraph a, b and c. There will be a pump pulling the water from the drainage pipe to the holding tank that leads to the filtering and recycling equipment. The drainage system is illustrated in FIG. 2.
   b. Public sewer connection to machine room is required to dispose of excess filtered water direct into the sewage system already established at the site.
   c. Public water connection to the machine room will be required to accommodate the water demand of rinsing the vehicle with fresh water as described in section 2 paragraph c. This connection will be insulated.
   d. Public electric power connection to machine room is required to power the machinery components, office, and lights for the entire facility.
   e. The entire structure will be located on a blacktop/asphalt surface that will require painting the lanes for vehicles to know the direction to enter and exit the facility.
2. The modular components and connectivity are described as follows:
   a. One 10′W, 25′L, and 8.5′H steel structure with double swing doors at both 10′ wide access points as illustrated in FIG. 5.1 and 5.2. This structure will have a drainage pipe below the center of the building and running the entire length of the structure as illustrated by FIG. 2. The structure will have vents installed in the center of the floor of this structure and connected to the drainage pipe to allow the water to run off into the drainage system as illustrated in FIG. 3; Lane 1. This structure will have two high pressure water arches that run along the side and ceiling of the structure, one of which will apply water, the second of which will apply the soap to the vehicle. The water will be delivered through pipes from the machine room and connected to the water tank that holds recycled water. The soap will be delivered through pipes coming from the machine room connected to the recycled water tank and chemical distribution system. Water pumps will provide the pressure required to pump the water and soap through the pipes.
   b. After the vehicle exits the first structure it will be driven onto a platform 10′W, 20′L, and 2″H that is floor vented to allow the soapy water run off to enter the drainage pipe as illustrated in FIG. 3; Lane 1. Hand washers will be located on each side of the platform to hand wash each vehicle using the soap already applied to the vehicle and hand mitts.
   c. After the vehicle is hand washed it will enter into the second structure that is 10′W, 25′L, and 8′6″H steel structure with double swing doors at both 10′ wide access points as illustrated in FIGS. 5.1 and 5.2. The structure will have vents installed in the center of the floor of this structure to allow the water to run off into the drainage pipe as illustrated in FIG. 3; Lane 1. This structure will have two high pressure water arches that run along the side and ceiling of the structure, both of which will apply fresh water to rinse off the vehicle. These arches will be connected direct to the public water source located in the machine room, and pressure by a water pump. At the end of this structure will be six commercial dryers that will be affixed to the exterior of the structure, with the structure cut out in certain section to allow the hot air from the dryer nozzle to dry the vehicle before exiting the structure. The commercial dryers will be powered by the public utilities and connected through the machine room.
   d. Along side the structure illustrated in paragraph a of this section will be the office, representing an 8′W, 20′L, and 8′6″H steel structure, insulated, ventilated and climate controlled using electric baseboard heat, and a window air conditioner as illustrated in FIGS. 7.1, 7.2, 7.3, and 7.4. This structure will be used as a waiting room for customers and a processing center for all transactions as illustrated in FIG. 7.5. This building will require a direct phone and cable line, and electric power provided by the public utilities in the machine room.
   e. Along side the platform described in paragraph b of this section will be an 8′W, 10′L open area used to hold vacuums and car cleaning products used in the final wash process before delivering the vehicle to the customer as illustrated in FIG. 3; Lane 2. These items will be held overnight in the secured machine room.
   f. Along side the structure illustrated in paragraph c of this section will be the machine room which represents an 8′W, 40′L, and 8′6″H steel structure, insulated, ventilated and climate controlled using electric baseboard heat as illustrated in FIG. 6. This building will be where the public utilities (water/sewage/electric) are brought to the structure and redistributed to the individual buildings; Water pipes and power lines leading to and from the structures illustrated in paragraph a and c of this section; Power lines, cable and phone to and from the office building; Input from the drainage pipe. Equipment and machinery located in this structure include water pumps, water tanks, water recycling equipment, electric panel, and chemical distribution control.
   g. The structure will have an environmentally friendly design by using water filtering and recycling equipment, and solar panels located on the rooftop to offset the public electric power used by the entire facility.
   h. Once assembled, a shell will be constructed around the sides and ceiling of all the structures to create the perception of one building as opposed to multiple modular structures as illustrated in FIGS. 8.1, 8.2, 8.3, 8.4, 8.5, 8.6, and 8.7. The shell will be made of flat aluminum siding panels, and secured to the exterior of the steel structures.
3. Interchangeable Aspects
   a. The modular structures proposed in paragraph 2 of this section are to be steel structures coated in a weatherproofing material on the interior and exterior of the facility.
   b. Each structure will be secured to the surface. Methods for securing the structures to the ground will differ based on the surface type. A bolt sleeve is recommended for securing the modular components to the surface area. Bolt sleeves will be located in each of the four corners of the interior for all four modular structures, and the open air platform
   c. The modular structures do not have to be made of steel, and the dimensions of each structure can be adjusted to reflect personal design preference. The size of the modular structures will be limited to reflect the restrictions for transporting the modular structures on a flat bed truck.
   d. The equipment used in the machine room and connectivity can differ based on personal preference regarding the design and capacity capabilities of the facility, including but not limited to the water recycling capabilities, size of water tanks and pumps, specific piping and power lines, power source and electric panel requirements, solar panel usage, chemical distribution control, use of a conveyor system or automated mitters and washers.
   e. Based on personal design preference, the exterior shell can be made of numerous materials that share the characteristic of being able to be assembled and disassembled with ease.

I claim:

1. That the modular structures, machinery and modes of connectivity that are currently available have never been assembled to create a mobile automated-hand car wash or any other structure will similar design or purpose.

2. A mobile automated-hand car wash facility that can be delivered via flat bed truck to any location; secured, assembled and connected to utilities for operation, with the ability to disassemble the modular structures and remove the entire facility leaving no damage to the property.
a. The entire facility is comprised of 4 modular buildings and 1 open air platform, totaling a 20′W*70′L*8′6″H structure, surrounded by one exterior shell of aluminum siding to create the perception of one single structure.
i. Modular buildings can be made of various materials
ii. Size of the individual and combined modular structures can vary based on design and capacity capability preference.
iii. Use of open air platform is required to combine the design of an automated car wash and hand wash operation while appropriately directing to water and soap run off to the drainage system.
b. The entire facility can be adjusted to reflect the design of a completely automated tunnel car wash system by using 2 modular structures, reducing the total facility area to 20′W*50′L*8′6″H. This design allows for a 8′W*10′L area to be used as an open air or enclosed office (processing) and waiting area.

3. A mobile automated-hand car wash facility with green designation.
a. The water used during the car wash processes will be filtered and recycled for reuse using existing equipment. Equipment will capture soap and residue from the vehicles serviced and properly disposed off to avoid the chemicals and residue from entering the public sewage system.
b. There will be solar panels on the entire rooftop to substitute public power supply regarding the operation of the mobile automated-hand car wash.
c. All chemicals used are VOC compliant and environmentally friendly, creating no adverse effect to the land or sewage system connected to the facility.
